(19) United States
(12) Patent Application Publication
(10) Pub. No.: US 2020/0382808 A1
(43) Pub. Date: Dec. 3, 2020

(54) VIDEO IMAGE ENCODER, A VIDEO IMAGE DECODER AND CORRESPONDING METHODS FOR MOTION INFORMATION CODING

(71) Applicant: Huawei Technologies Co., Ltd., Shenzhen (CN)

(72) Inventors: Ruslan Faritovich MULLAKHMETOV, Moscow (RU); Sergey Yurievich IKONIN, Moscow (RU); Maxim Borisovitch SYCHEV, Moscow (RU)

(21) Appl. No.: 16/999,939

(22) Filed: Aug. 21, 2020

Related U.S. Application Data
(63) Continuation of application No. PCT/RU2018/000189, filed on Mar. 26, 2018.

(51) Int. Cl. H04N 19/567; H04N 19/184

(52) U.S. Cl. CPC H04N 19/567; H04N 19/184

(57) ABSTRACT

The present invention relates to the field of video pictures/images processing. In particular, the present invention relates to a device for decoding video images, and to a device for encoding video images. The invention is especially concerned with reducing the amount of information transmitted from the encoding device to the decoding device. Only absolute values of motion information are transmitted according to the invention from the encoding device to the decoding device. Both the encoding device and the decoding device use the absolute values of the motion information to build motion information candidates of the generated motion information, wherein each motion information candidate results from a different sign combination of the absolute values, calculate a cost for each motion information candidate, and determine a rank of each motion information candidate based on the calculated costs.

### CROSS-REFERENCE TO RELATED APPLICATIONS

This application is a continuation of International Application No. PCT/RU2018/000189, filed on Mar. 26, 2018, the disclosure of which is hereby incorporated by reference in its entirety.

### TECHNICAL FIELD

Embodiments of the present disclosure relate to the field of video pictures processing, for example video picture/image coding. In particular, embodiments of the present disclosure relate to a device for decoding video images (e.g., a video image decoder) and to a device for encoding video images (e.g., a video image encoder). Further, the present disclosure relates to corresponding methods for decoding and encoding video images, respectively.

### BACKGROUND

Video coding (e.g., video encoding and decoding) is used in a wide range of digital video applications, for example, broadcast digital TV, video transmission over internet and mobile networks, real-time conversational applications such as video chat, video conferencing, DVD and Blu-ray discs, video content acquisition and editing systems, and camcorders of security applications.

Since the development of the block-based hybrid video coding approach in the H.261 standard in 1990, new video coding techniques and tools were developed and formed the basis for new video coding standards. One of the goals of most of the video coding standards was to achieve a bitrate reduction compared to its predecessor without sacrificing picture quality. Further video coding standards comprise MPEG-1 video, MPEG-2 video, ITU-T H.262/MPEG-2, ITU-T H.263, ITU-T H.264/MPEG-4, Part 10, Advanced Video Coding (AVC), ITU-T H.265, High Efficiency Video Coding (HEVC), and extensions, e.g., scalability and/or three-dimensional (3D) extensions, of these standards.

In hybrid video coding, Inter Prediction supported by Inter Estimation is used in the encoder to utilize temporal redundancy in video sequences. This allows reducing the amount of information that needs to be transmitted from the encoder to the decoder. In particular, the Inter Estimation yields motion information that is transmitted along with other information from the encoder to the decoder. Typically, this motion information comprises Motion Vectors (MVs) in different forms. The Inter Prediction in the encoder ensures that the encoder and decoder are in a synchronized state, and is the same as in the decoder. In the decoder, the Inter Prediction is used to reconstruct the temporal redundancy using the motion information transmitted from the encoder.

One form of transmitted motion information is a pair of a Motion Vector Predictor (MVP) index and Motion Vector Difference (MVD). A MVP is a vector from a list of vectors constructed in the same way in the encoder/decoder for a given coding unit. A MVP index is an index of an MVP in said MVP list. A MVD is a difference between a motion vector (MV) found by Inter Estimation and a selected MVP. The MVD is by definition a 2D vector.

At present, a MVD is transmitted from the encoder to the decoder, and the transmission process is depicted in FIG. 15. At first, absolute values (x, y) of the MVD are transmitted using an entropy coder with a non uniform probability model. Then, for non-zero components, signs are transmitted in an equal probability (EP) mode, which requires the signaling of 1 bit for each sign. In most cases the signs of the MVD are uniformly distributed, and thus no additional compression efficiency can be achieved, e.g., using Context-Adaptive Binary Arithmetic Coding (CABAC).

### SUMMARY

In view of the above-mentioned implementations, the present disclosure aims to further improve hybrid video coding. In particular, the present disclosure has the objective to reduce the amount of information that is transmitted from the encoder to the decoder, without sacrificing on image quality. Therefore, the present disclosure intends to provide a device for encoding video images and a device for decoding video images, respectively, which enables a further reduction of the information transmitted (e.g., encoded onto a bitstream from the encoder to the decoder).

The objective of the present disclosure is solved according to embodiments of the disclosure defined by the features of the independent claims. Further advantageous implementations of the embodiments are defined by the features of the dependent claims.

In particular, the present disclosure proposes not to transmit signs of the motion information, but only the absolute values of the motion information, e.g., MVD components (x component and y component) from the encoder to the decoder. Instead, the present disclosure proposes a way to derive the signs in the decoder without adding much computational complexity, e.g., by using template or bilateral matching, and including using some transmitted auxiliary information.

A first aspect of the present disclosure provides a device for decoding video images, comprising a receiver configured to receive absolute values of motion information, and a processor configured to generate motion information candidates based on the received absolute values, calculate a cost for each motion information candidate, determine a rank of each motion information candidate based on the calculated costs, and determine a motion information candidate to be the motion information based on the determined rank. Each motion information candidate results from a different sign combination of the absolute values.

The device may be a video image decoder, or may be implemented by such a decoder. Since the decoding device is able to determine the motion information without receiving the signs of the motion information, these signs do not need to be transmitted by the encoder. Accordingly, the amount of information encoded by the encoder onto the bitstream to the decoder is reduced. The determination of the motion information in the decoding device does not add much computational complexity, and does not influence the decoding efficiency of the decoding device.

The motion information may include MV, MVP and/or MVD. The disclosure may be applied to different motion models. For instance, it may be applied to translational, affine, or perspective models. Accordingly, the motion information may include an MVD or MV transmitted directly. The disclosure may also be applied to an affine motion model where the motion information may include a list of MV/MVD. In this case the number of motion information candidates is 2^{2N} where N is the length of the MV/MVD list produced by the motion model. Notably, the translation model can be thought of a producing a list of MVD of length l.

The absolute values of the motion information may be absolute values of the MV or MVD. The motion information candidates are determined based on the received absolute values, for instance, absolute MVD components. For, example, for a received sign-less MVD (x, y), with x≥0, y≥0, the candidates may be [(x, y), (x, −y), (−x, y), (−x, −y)]. For zero-value components trivial combinations may be excluded from the list, e.g., (x, y)=(−x, y) for x=0 and (x, y)=(x, −y) for y=0.

A cost of a motion information candidate may reflect a probability that the motion information candidate is the correct motion information. For instance, the lower the cost of the motion information candidate, the higher this probability. A rank of a motion information candidate may accordingly be information that reflects its cost relative to other motion information candidates. For instance, the lower its cost compared to the others, the higher its rank.

In an implementation form of the first aspect, the receiver is further configured to receive a rank, and the processor is configured to determine a motion information candidate with a rank according to the received rank to be the motion information.

The rank may be, like the absolute values of the motion information, received from a bitstream encoded by an encoding device, i.e., transmitted by the encoding device to the decoding device. The rank is auxiliary information, which allows the decoding device to determine the motion information fast and precisely.

In a further implementation form of the first aspect, the received rank is an index, and the processor is configured to generate an indexed list of the motion information candidates sorted by their ranks and determine a motion information candidate with an index in the indexed list according to the received index to be the motion information.

As described above, a candidate with higher rank (meaning lower cost) is more probable to be a correct motion information than other candidates with lower rank (higher cost). A method of coding of rank index may utilize this fact to reduce the amount of information to transmit by using adaptive context of CABAC and/or use non-uniformly distributed codes like, e.g., unary or Golomb codes giving shorter code words to higher rank candidates.

In this implementation form, only an index may be transmitted from the encoder to the decoder, which adds only a small amount of additional information. Nevertheless, the decoding device is configured to accurately determine the correct motion information based on the absolute values received.

In a further implementation form of the first aspect, the processor is configured to determine a motion information candidate with a rank corresponding to a lowest calculated cost to be the motion information.

In this implementation form, the decoding device does not require any auxiliary information (like the rank or index described above) from the encoding device. Accordingly, the amount of information transmitted from the encoder to the decoder can be as small as possible. Notably, even if auxiliary information (rank, index) is transmitted, in most cases the motion information candidate with the best rank, lowest cost or lowest index is the true motion information. Thus, this implementation avoids transmission of rank/index.

In a further implementation form of the first aspect, the processor is configured to calculate the cost for each motion information candidate by template or bilateral matching, particularly based on a sum of absolute differences or another distortion metric.

Conventional template or bilateral matching techniques can be used.

In a further implementation form of the first aspect, the processor is configured to exclude one of two motion information candidates, which differ only in the sign of at least one zero value.

Accordingly, the list becomes shorter and determining the correct motion information is more efficient, allowing the processor to reduce the amount of matching operations.

In a further implementation form of the first aspect, the processor is configured to calculate the cost for each motion information candidate taking into account the amount of bits it would require to transmit the rank of each motion information candidate.

Thus, an improved cost metric is used, in order to achieve better results.

A second aspect of the present disclosure provides a device for encoding video images, comprising a processor configured to generate motion information, build motion information candidates based on absolute values of the generated motion information, calculate a cost for each motion information candidate, and determine a rank of each motion information candidate based on the calculated costs; and a transmitter configured to transmit the absolute values of the generated motion information based on the determined ranks. Each motion information candidate results from a different sign combination of the absolute values.

The encoding device transmits the absolute values, particularly without the signs of the motion information. Accordingly, the amount of information encoded onto a bitstream to a decoding device can be reduced. The term “based on the determined ranks” does not necessarily imply that a rank is transmitted as well. It only means that the encoding device takes into account the determined ranks when performing the transmitting step. Different ways to take into account the determined ranks are explained below.

In an implementation form of the second aspect, the transmitter is configured to transmit the rank of the motion information candidate corresponding to the generated motion information.

That is, the encoding device transmits the absolute values of the generated motion information, and its rank according to the determined ranks. In this implementation form, the term “based on the determined ranks” means that the rank of the motion information candidate corresponding to the generated motion information is also transmitted along with the absolute values. The rank serves as auxiliary information to facilitate the determination of the motion information in the decoding device.

In a further implementation form of the second aspect, the processor is configured to calculate the cost for each motion information candidate taking into account the amount of bits it would require to transmit its rank.

Thus, an improved cost metric is used, in order to achieve better results.

In a further implementation form of the second aspect, the processor is configured to generate an indexed list of the motion information candidates sorted by their ranks, and determine an index in the indexed list of the motion information candidate corresponding to the generated motion information, and the transmitter is configured to transmit the determined index.

The rank of the generated motion information accordingly corresponds to the determined index, and the transmitted index serves as auxiliary information at the decoding device. The determined ranks, list and indices are the same at encoding and decoding device.

In a further implementation form of the second aspect, the processor is configured to determine whether a motion information candidate with a rank according to a lowest calculated cost corresponds to the generated motion information, and discard the generated motion information, if the determined motion information candidate does not correspond to the generated motion information.

In this implementation form, the term “based on the determined ranks” means that the encoding device only transmits the absolute values, if the rank determined for the generated motion information correlates to the lowest calculated cost. Otherwise, the generated motion information is discarded, and its absolute values are not transmitted. Discarding may mean that the encoder chooses another motion information, or chooses another encoding mode. This implementation form prevents false determinations of the correct motion information in the decoding device, since the decoding device of the first aspect takes the motion information of lowest cost as correct motion information.

In a further implementation form of the second aspect, the processor is configured to calculate the cost for each motion information candidate by template or bilateral matching, particularly based on a sum of absolute differences or another distortion metric.

This has the same advantages as described above with respect to the decoding device of the first aspect.

In a further implementation form of the second aspect, the processor is configured to exclude one of two motion information candidates, which differ only in the sign of at least one zero value.

A third aspect of the present disclosure provides a method for decoding video images, comprising receiving absolute values of motion information, generating motion information candidates based on the received absolute values, wherein each motion information candidate results from a different sign combination of the absolute values, calculating a cost for each motion information candidate, determining a rank of each motion information candidate based on the calculated costs, and determining a motion information candidate to be the motion information based on the determined ranks.

In an implementation form of the third aspect, the method comprises receiving a rank, and determining a motion information candidate with a rank according to the received rank to be the motion information.

In a further implementation form of the third aspect, the received rank is an index, and the method comprises generating an indexed list of the motion information candidates sorted by their ranks, and determining a motion information candidate with an index in the indexed list according to the received index to be the motion information.

In a further implementation form of the third aspect, the method comprises determining a motion information candidate with a rank corresponding to a lowest calculated cost to be the motion information.

In a further implementation form of the third aspect, the method comprises calculating the cost for each motion information candidate by template or bilateral matching, particularly based on a sum of absolute differences or another distortion metric.

In a further implementation form of the third aspect, the method comprises excluding one of two motion information candidates, which differ only in the sign of at least one zero value.

In a further implementation form of the third aspect, the method comprises calculating the cost for each motion information candidate taking into account the amount of bits it would require to transmit the rank of each motion information candidate.

The method of the third aspect and its implementation forms achieves the same advantages and effects as the decoding device of the first aspect and its respective implementation forms.

A fourth aspect of the present disclosure provides a method for encoding video images, comprising generating motion information, building motion information candidates based on absolute values of the generated motion information, calculating a cost for each motion information candidate, determining a rank of each motion information candidate based on the calculated costs, and transmitting the absolute values of the input motion information based on the determined ranks. Each motion information candidate results from a different sign combination of the absolute values.

In an implementation form of the fourth aspect, the method comprises transmitting the rank of the motion information candidate corresponding to the generated motion information.

In a further implementation form of the fourth aspect, the method comprises calculating the cost for each motion information candidate taking into account the amount of bits it would require to transmit its rank.

In a further implementation form of the fourth aspect, the method comprises generating an indexed list of the motion information candidates sorted by their ranks, and determining an index in the indexed list of the motion information candidate corresponding to the generated motion information, and the transmitter is configured to transmit the determined index.

In a further implementation form of the fourth aspect, the method comprises determining whether a motion information candidate with a rank according to a lowest calculated cost corresponds to the generated motion information, and discarding the generated motion information, if the determined motion information candidate does not correspond to the generated motion information.

In a further implementation form of the fourth aspect, the method comprises calculating the cost for each motion information candidate by template or bilateral matching, particularly based on a sum of absolute differences or another distortion metric.

In a further implementation form of the fourth aspect, the method excluding one of two motion information candidates, which differ only in the sign of at least one zero value.

The method of the fourth aspect and its implementation forms achieves the same advantages and effects as the encoding device of the second aspect and its respective implementation forms.

According to a fifth aspect, a computer program product is provided. The computer program product stores program code for performing, when the computer program runs on a computer, the method according to the third and fourth aspects and further implementations thereof.

It has to be noted that all devices, elements, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

Details of one or more embodiments are set forth in the accompanying drawings and the description below. Other features, objects, and advantages will be apparent from the description, drawings, and claims.

### BRIEF DESCRIPTION OF THE DRAWINGS

In the following embodiments of the disclosure are described in more detail with reference to the attached figures and drawings, in which:

FIG. 1 is a block diagram showing an example structure of a video encoder configured to implement embodiments of the disclosure.

FIG. 2 is a block diagram showing an example structure of a video decoder configured to implement embodiments of the disclosure.

FIG. 3 is a block diagram showing an example of a video coding system configured to implement embodiments of the disclosure.

FIG. 4 is a block diagram showing a device for encoding video images according to an embodiment of the disclosure.

FIG. 5 is a block diagram showing a device for decoding video images according to an embodiment of the disclosure.

FIG. 6 shows schematically a method for encoding video images according to an embodiment of the disclosure.

FIG. 7 shows schematically a method for decoding video images according to an embodiment of the disclosure.

FIG. 8 shows a flow diagram of a MVD transmission according to embodiments of the disclosure.

FIG. 9 shows a flow diagram of a MVD transmission according to embodiments of the disclosure.

FIG. 10 shows a block diagram of an implementation of an embodiment of the disclosure in a video encoder.

FIG. 11 shows a block diagram of an implementation of an embodiment of the disclosure in a video encoder

FIG. 12 shows a block diagram of an implementation of an embodiment of the disclosure in a video decoder

FIG. 13 shows a block diagram of an implementation of an embodiment of the disclosure in a video decoder

FIG. 14 shows a flow diagram of a MVD candidate list construction according to embodiments of the disclosure.

FIG. 15 shows MVD transmission in a hybrid codec.

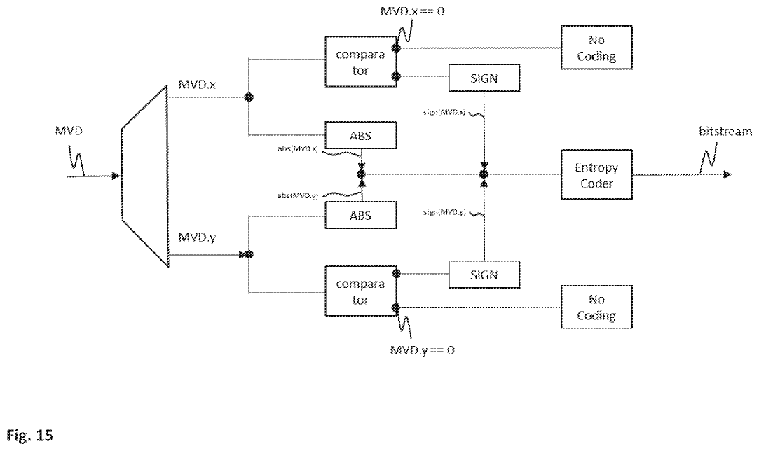

### DETAILED DESCRIPTION OF THE EMBODIMENTS

In the following description, reference is made to the accompanying figures, which form part of the disclosure, and which show, by way of illustration, specific aspects of embodiments of the disclosure or specific aspects in which embodiments of the present disclosure may be used. It is understood that embodiments of the disclosure may be used in other aspects and comprise structural or logical changes not depicted in the figures. The following detailed description, therefore, is not to be taken in a limiting sense, and the scope of the present disclosure is defined by the appended claims.

For instance, it is understood that a disclosure in connection with a described method may also hold true for a corresponding device or system configured to perform the method and vice versa. For example, if one or a plurality of specific method steps are described, a corresponding device may include one or a plurality of units, e.g., functional units, to perform the described one or plurality of method steps (e.g., one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g., functional units, a corresponding method may include one step to perform the functionality of the one or plurality of units (e.g., one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

Video coding typically refers to the processing of a sequence of pictures, which form the video or video sequence. Instead of the term picture, the terms frame or image may be used as synonyms in the field of video coding. Video coding comprises two parts, video encoding and video decoding. Video encoding is performed at the source side, typically comprising processing (e.g., by compression) the original video pictures to reduce the amount of data required for representing the video pictures (e.g., for more efficient storage and/or transmission). Video decoding is performed at the destination side and typically comprises the inverse processing compared to the encoder to reconstruct the video pictures. Embodiments referring to “coding” of video pictures (or video images or pictures in general, as will be explained later) shall be understood to relate to both, “encoding” and “decoding” of video pictures. The combination of the encoding part and the decoding part is also referred to as CODEC (COding and DECoding).

In the case of lossless video coding, the original video pictures can be reconstructed; i.e., the reconstructed video pictures have the same quality as the original video pictures (assuming no transmission loss or other data loss during storage or transmission). In the case of lossy video coding, further compression, e.g., by quantization, is performed, to reduce the amount of data representing the video pictures, which cannot be completely reconstructed at the decoder; i.e., the quality of the reconstructed video pictures is lower or worse compared to the quality of the original video pictures.

Several video coding standards since H.261 belong to the group of “lossy hybrid video codecs” (i.e., combine spatial and temporal prediction in the sample domain and 2D transform coding for applying quantization in the transform domain). Each picture of a video sequence is typically partitioned into a set of non-overlapping blocks and the coding is typically performed on a block level. In other words, at the encoder the video is typically processed, i.e. encoded, on a block (video block) level, e.g. by using spatial (intra picture) prediction and temporal (inter picture) prediction to generate a prediction block, subtracting the prediction block from the current block (block currently processed/to be processed) to obtain a residual block, transforming the residual block and quantizing the residual block in the transform domain to reduce the amount of data to be transmitted (compression), whereas at the decoder the inverse processing compared to the encoder is applied to the encoded or compressed block to reconstruct the current block for representation. Furthermore, the encoder duplicates the decoder processing loop such that both will generate identical predictions (e.g. intra- and inter predictions) and/or re-constructions for processing, i.e. coding, the subsequent blocks.

As video picture processing (also referred to as moving picture processing) and still picture processing (the term processing comprising coding), share many concepts and technologies or tools, in the following the term “picture” is used to refer to a video picture of a video sequence (as explained above) and/or to a still picture to avoid unnecessary repetitions and distinctions between video pictures and still pictures, where not necessary. In case the description refers to still pictures (or still images) only, the term “still picture” shall be used.

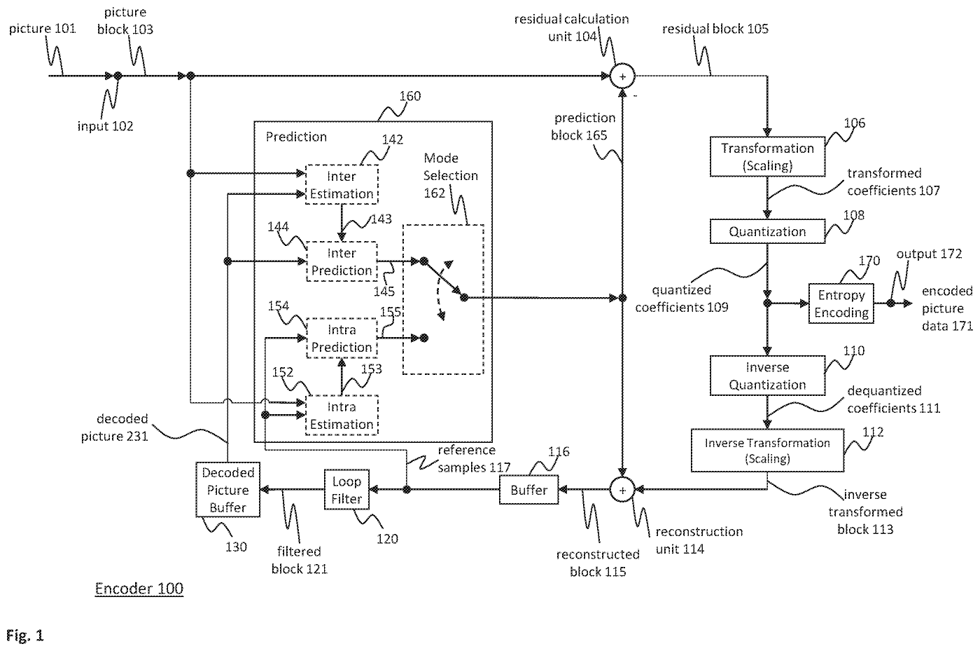

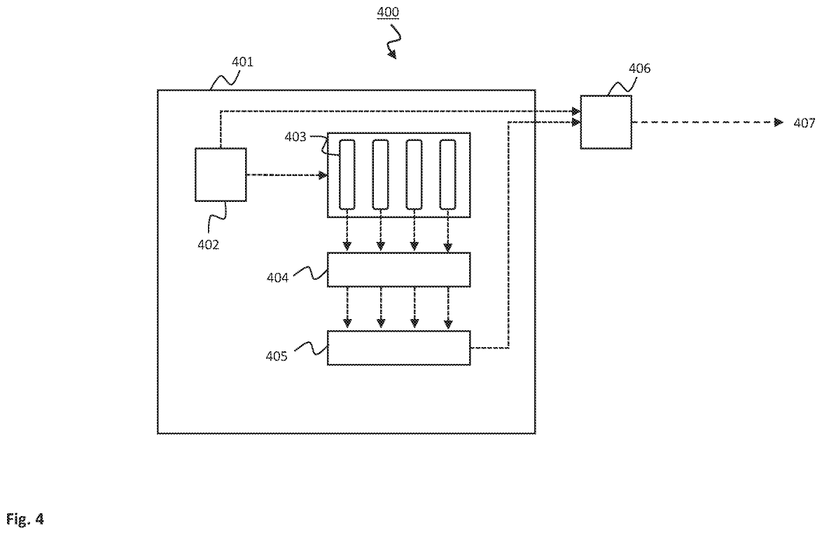

In the following an encoder 100, a decoder 200 and a coding system 300 for implementing embodiments of the disclosure are described based on FIGS. 1 to 3, before describing the embodiments of the disclosure in more detail based on FIGS. 4 to 11.

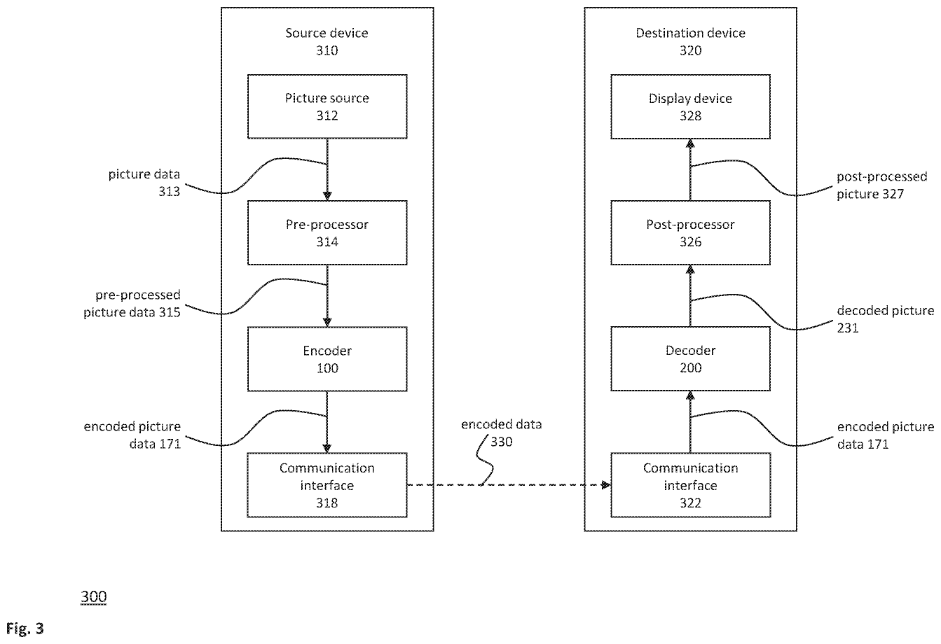

FIG. 3 is a conceptual or schematic block diagram illustrating an embodiment of a coding system 300, e.g., a picture coding system 300, wherein the coding system 300 comprises a source device 310 configured to provide encoded data 330, e.g., an encoded picture 330, e.g., to a destination device 320 for decoding the encoded data 330.

The source device 310 comprises an encoder 100 or encoding unit 100, and may additionally, i.e., optionally, comprise a picture source 312, a pre-processing unit 314, e.g., a picture pre-processing unit 314, and a communication interface or communication unit 318.

The picture source 312 may comprise or be any kind of picture capturing device, for example, for capturing a real-world picture, and/or any kind of a picture generating device, for example, a computer-graphics processor for generating a computer animated picture, or any kind of device for obtaining and/or providing a real-world picture, a computer animated picture (e.g. a screen content, a virtual reality (VR) picture) and/or any combination thereof (e.g. an augmented reality (AR) picture). In the following, all these kinds of pictures and any other kind of picture will be referred to as “picture”, unless specifically described otherwise, while the previous explanations with regard to the term “picture” covering “video pictures”, “video images”, “still images”, and “still pictures” still hold true, unless explicitly specified differently.

A (digital) picture is or can be regarded as a two-dimensional array or matrix of samples with intensity values. A sample in the array may also be referred to as a pixel (short form of picture element) or a pel. The number of samples in a horizontal and a vertical direction (or axis) of the array or picture defines the size and/or resolution of the picture. For representation of color, typically three color components are employed, i.e., the picture may be represented or include three sample arrays. In an RBG format or color space a picture comprises a corresponding red, green and blue sample array. However, in video coding each pixel is typically represented in a luminance/chrominance format or color space, e.g., a YCbCr format, which comprises a luminance component indicated by Y (sometimes also L is used instead) and two chrominance components indicated by Cb and Cr. The luminance (or short luma) component Y represents the brightness or grey level intensity (e.g., like in a grey-scale picture), while the two chrominance (or short chroma) components Cb and Cr represent the chromaticity or color information components. Accordingly, a picture in the YCbCr format comprises a luminance sample array of luminance sample values (Y), and two chrominance sample arrays of chrominance values (Cb and Cr). Pictures in RGB format may be converted or transformed into YCbCr format and vice versa, the process is also known as color transformation or conversion. If a picture is monochrome, the picture may comprise only a luminance sample array.

The picture source 312 may be, for example, a camera for capturing a picture, a memory, e.g., a picture memory, comprising or storing a previously captured or generated picture, and/or any kind of interface (internal or external) to obtain or receive a picture. The camera may be, for example, a local or integrated camera integrated in the source device, the memory may be a local or integrated memory, e.g., integrated in the source device. The interface may be, for example, an external interface to receive a picture from an external video source, for example, an external picture capturing device like a camera, an external memory, or an external picture generating device, for example, an external computer-graphics processor, computer or server. The interface can be any kind of interface, e.g., a wired or wireless interface, an optical interface, according to any proprietary or standardized interface protocol. The interface for obtaining the picture data 312 may be the same interface as or a part of the communication interface 318.

In distinction to the pre-processing unit 314 and the processing performed by the pre-processing unit 314, the picture or picture data 313 may also be referred to as a raw picture or raw picture data 313.

Pre-processing unit 314 is configured to receive the (raw) picture data 313 and to perform pre-processing on the picture data 313 to obtain a pre-processed picture 315 or pre-processed picture data 315. Pre-processing performed by the pre-processing unit 314 may, e.g., comprise trimming, color format conversion (e.g., from RGB to YCbCr), color correction, or de-noising.

The encoder 100 is configured to receive the pre-processed picture data 315 and provide encoded picture data 171 (further details will be described, e.g., based on FIG. 1).

Communication interface 318 of the source device 310 may be configured to receive the encoded picture data 171 and to directly transmit it to another device, e.g., the destination device 320 or any other device, for storage or direct reconstruction, or to process the encoded picture data 171 for respectively before storing the encoded data 330 and/or transmitting the encoded data 330 to another device, e.g., the destination device 320 or any other device for decoding or storing.

The destination device 320 comprises a decoder 200 or decoding unit 200, and may additionally, i.e., optionally, comprise a communication interface or communication unit 322, a post-processing unit 326 and a display device 328.

The communication interface 322 of the destination device 320 is configured receive the encoded picture data 171 or the encoded data 330, e.g., directly from the source device 310 or from any other source, e.g., a memory, e.g., an encoded picture data memory.

The communication interface 318 and the communication interface 322 may be configured to transmit respectively receive the encoded picture data 171 or encoded data 330 via a direct communication link between the source device 310 and the destination device 320, e.g., a direct wired or wireless connection, or via any kind of network, e.g., a wired or wireless network or any combination thereof, or any kind of private and public network, or any kind of combination thereof.

The communication interface 318 may be, e.g., configured to package the encoded picture data 171 into an appropriate format, e.g., packets, for transmission over a communication link or communication network, and may further comprise data loss protection and data loss recovery.

The communication interface 322, forming the counterpart of the communication interface 318, may be, e.g., configured to de-package the encoded data 330 to obtain the encoded picture data 171 and may further be configured to perform data loss protection and data loss recovery, e.g. comprising error concealment.

Both, communication interface 318 and communication interface 322 may be configured as unidirectional communication interfaces as indicated by the arrow for the encoded picture data 330 in FIG. 3 pointing from the source device 310 to the destination device 320, or bi-directional communication interfaces, and may be configured, e.g. to send and receive messages, e.g. to set up a connection, to acknowledge and/or re-send lost or delayed data including picture data, and exchange any other information related to the communication link and/or data transmission, e.g., encoded picture data transmission.

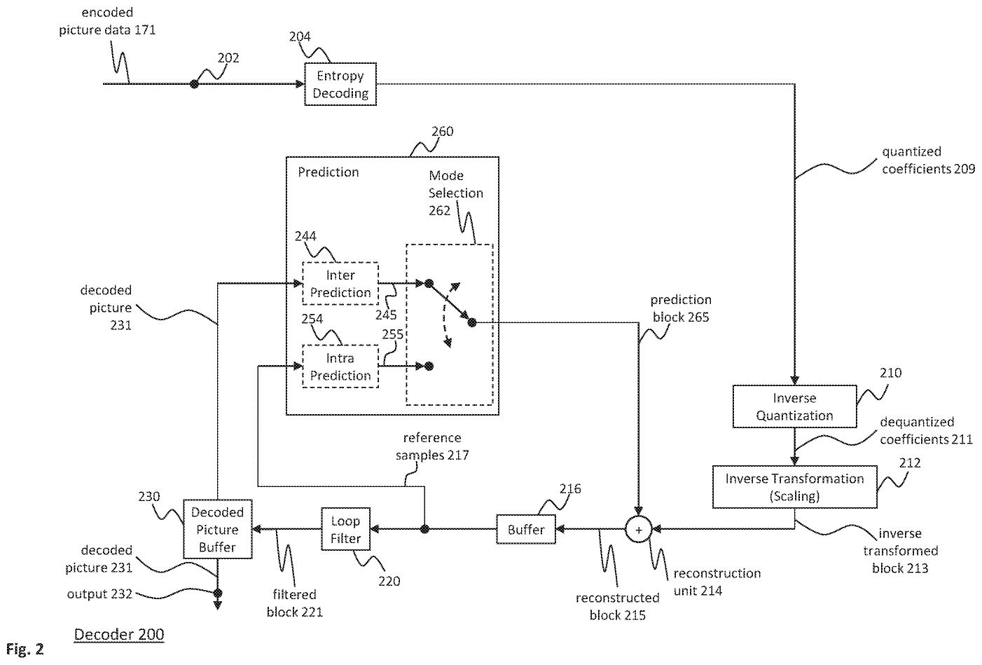

The decoder 200 is configured to receive the encoded picture data 171 and provide decoded picture data 231 or a decoded picture 231 (further details will be described, e.g., based on FIG. 2).

The post-processor 326 of destination device 320 is configured to post-process the decoded picture data 231, e.g., the decoded picture 231, to obtain post-processed picture data 327, e.g., a post-processed picture 327. The post-processing performed by the post-processing unit 326 may comprise, e.g., color format conversion (e.g. from YCbCr to RGB), color correction, trimming, or re-sampling, or any other processing, e.g., for preparing the decoded picture data 231 for display, e.g., by display device 328.

The display device 328 of the destination device 320 is configured to receive the post-processed picture data 327 for displaying the picture, e.g., to a user or viewer. The display device 328 may be or comprise any kind of display for representing the reconstructed picture, e.g., an integrated or external display or monitor. The displays may, e.g., comprise cathode ray tubes (CRT), liquid crystal displays (LCD), plasma displays, organic light emitting diodes (OLED) displays or any kind of other display, beamer, or hologram (3D).

Although FIG. 3 depicts the source device 310 and the destination device 320 as separate devices, embodiments of devices may also comprise both or both functionalities, the source device 310 or corresponding functionality and the destination device 320 or corresponding functionality. In such embodiments the source device 310 or corresponding functionality and the destination device 320 or corresponding functionality may be implemented using the same hardware and/or software or by separate hardware and/or software or any combination thereof.

As will be apparent for the skilled person based on the description, the existence and (exact) split of functionalities of the different units or functionalities within the source device 310 and/or destination device 320 as shown in FIG. 3 may vary depending on the actual device and application.

Therefore, the source device 310 and the destination device 320 as shown in FIG. 3 are just example embodiments of the disclosure and embodiments of the disclosure are not limited to those shown in FIG. 3.

Source device 310 and destination device 320 may comprise any of a wide range of devices, including any kind of handheld or stationary devices, e.g., notebook or laptop computers, mobile phones, smart phones, tablets or tablet computers, cameras, desktop computers, set-top boxes, televisions, display devices, digital media players, video gaming consoles, video streaming devices, broadcast receiver device, or the like, and may use no or any kind of operating system.

### Encoder & Encoding Method

FIG. 1 shows a schematic/conceptual block diagram of an embodiment of an encoder 100, e.g., a picture encoder 100, which comprises an input 102, a residual calculation unit 104, a transformation unit 106, a quantization unit 108, an inverse quantization unit 110, and inverse transformation unit 112, a reconstruction unit 114, a buffer 118, a loop filter 120, a decoded picture buffer (DPB) 130, a prediction unit 160 (including an inter estimation unit 142, an inter prediction unit 144, an intra estimation unit 152, and an intra prediction unit 154) a mode selection unit 162, an entropy encoding unit 170, and an output 172. A video encoder 100 as shown in FIG. 1 may also be referred to as hybrid video encoder or a video encoder according to a hybrid video codec.

For example, the residual calculation unit 104, the transformation unit 106, the quantization unit 108, and the entropy encoding unit 170 form a forward signal path of the encoder 100, whereas, for example, the inverse quantization unit 110, the inverse transformation unit 112, the reconstruction unit 114, the buffer 118, the loop filter 120, the decoded picture buffer (DPB) 130, the inter prediction unit 144, and the intra-prediction unit 154 form a backward signal path of the encoder, wherein the backward signal path of the encoder corresponds to the signal path of the decoder (see decoder 200 in FIG. 2).

The encoder 100 is configured to receive, e.g., by input 102, a picture 101 or a picture block 103 of the picture 101, e.g., picture of a sequence of pictures forming a video or video sequence. The picture block 103 may also be referred to as current picture block or picture block to be coded, and the picture 101 as current picture or picture to be coded (in particular in video coding to distinguish the current picture from other pictures, e.g., previously encoded and/or decoded pictures of the same video sequence, i.e., the video sequence which also comprises the current picture).

### Residual Calculation

The residual calculation unit 104 is configured to calculate a residual block 105 based on the picture block 103 and a prediction block 165 (further details about the prediction block 165 are provided later), e.g., by subtracting sample values of the prediction block 165 from sample values of the picture block 103, sample by sample (pixel by pixel) to obtain the residual block 105 in the sample domain.

### Transformation

The transformation unit 106 is configured to apply a transformation, e.g., a spatial frequency transform or a linear spatial (frequency) transform, e.g., a discrete cosine transform (DCT) or discrete sine transform (DST), on the sample values of the residual block 105 to obtain transformed coefficients 107 in a transform domain. The transformed coefficients 107 may also be referred to as transformed residual coefficients and represent the residual block 105 in the transform domain.

The transformation unit 106 may be configured to apply integer approximations of DCT/DST, such as the core transforms specified for HEVC/H.265. Compared to an orthonormal DCT transform, such integer approximations are typically scaled by a certain factor. In order to preserve the norm of the residual block which is processed by forward and inverse transforms, additional scaling factors are applied as part of the transform process. The scaling factors are typically chosen based on certain constraints like scaling factors being a power of two for shift operation, bit depth of the transformed coefficients, trade-off between accuracy and implementation costs, etc. Specific scaling factors are, for example, specified for the inverse transform, e.g., by inverse transformation unit 212, at a decoder 200 (and the corresponding inverse transform, e.g., by inverse transformation unit 112 at an encoder 100) and corresponding scaling factors for the forward transform, e.g., by transformation unit 106, at an encoder 100 may be specified accordingly.

### Quantization

The quantization unit 108 is configured to quantize the transformed coefficients 107 to obtain quantized coefficients 109, e.g., by applying scalar quantization or vector quantization. The quantized coefficients 109 may also be referred to as quantized residual coefficients 109. For example, for scalar quantization, different scaling may be applied to achieve finer or coarser quantization. Smaller quantization step sizes correspond to finer quantization, whereas larger quantization step sizes correspond to coarser quantization. The applicable quantization step size may be indicated by a quantization parameter (QP). The quantization parameter may, for example, be an index to a predefined set of applicable quantization step sizes. For example, small quantization parameters may correspond to fine quantization (small quantization step sizes) and large quantization parameters may correspond to coarse quantization (large quantization step sizes) or vice versa. The quantization may include division by a quantization step size and corresponding or inverse dequantization, e.g., by inverse quantization 110, may include multiplication by the quantization step size. Embodiments according to HEVC, may be configured to use a quantization parameter to determine the quantization step size. Generally, the quantization step size may be calculated based on a quantization parameter using a fixed point approximation of an equation including division. Additional scaling factors may be introduced for quantization and dequantization to restore the norm of the residual block, which might get modified because of the scaling used in the fixed point approximation of the equation for quantization step size and quantization parameter. In one example implementation, the scaling of the inverse transform and dequantization might be combined. Alternatively, customized quantization tables may be used and signaled from an encoder to a decoder, e.g., in a bitstream. The quantization is a lossy operation, wherein the loss increases with increasing quantization step sizes.

Embodiments of the encoder 100 (or respectively of the quantization unit 108) may be configured to output the quantization scheme and quantization step size, e.g., by means of the corresponding quantization parameter, so that a decoder 200 may receive and apply the corresponding inverse quantization. Embodiments of the encoder 100 (or quantization unit 108) may be configured to output the quantization scheme and quantization step size, e.g., directly or entropy encoded via the entropy encoding unit 170 or any other entropy coding unit.

The inverse quantization unit 110 is configured to apply the inverse quantization of the quantization unit 108 on the quantized coefficients to obtain dequantized coefficients 111, e.g., by applying the inverse of the quantization scheme applied by the quantization unit 108 based on or using the same quantization step size as the quantization unit 108. The dequantized coefficients 111 may also be referred to as dequantized residual coefficients 111 and correspond—although typically not identical to the transformed coefficients due to the loss by quantization—to the transformed coefficients 108.

The inverse transformation unit 112 is configured to apply the inverse transformation of the transformation applied by the transformation unit 106, e.g., an inverse discrete cosine transform (DCT) or inverse discrete sine transform (DST), to obtain an inverse transformed block 113 in the sample domain. The inverse transformed block 113 may also be referred to as inverse transformed dequantized block 113 or inverse transformed residual block 113.

The reconstruction unit 114 is configured to combine the inverse transformed block 113 and the prediction block 165 to obtain a reconstructed block 115 in the sample domain, e.g., by sample wise adding the sample values of the decoded residual block 113 and the sample values of the prediction block 165.

The buffer unit 116 (or short “buffer” 116), e.g., a line buffer 116, is configured to buffer or store the reconstructed block and the respective sample values, for example, for intra estimation and/or intra prediction. In further embodiments, the encoder may be configured to use unfiltered reconstructed blocks and/or the respective sample values stored in buffer unit 116 for any kind of estimation and/or prediction.

The loop filter unit 120 (or short “loop filter” 120), is configured to filter the reconstructed block 115 to obtain a filtered block 121, e.g., by applying a de-blocking sample-adaptive offset (SAO) filter or other filters, e.g., sharpening or smoothing filters or collaborative filters. The filtered block 121 may also be referred to as filtered reconstructed block 121.

Embodiments of the loop filter unit 120 may comprise (not shown in FIG. 1) a filter analysis unit and the actual filter unit, wherein the filter analysis unit is configured to determine loop filter parameters for the actual filter. The filter analysis unit may be configured to apply fixed pre-determined filter parameters to the actual loop filter, adaptively select filter parameters from a set of predetermined filter parameters or adaptively calculate filter parameters for the actual loop filter.

Embodiments of the loop filter unit 120 may comprise (not shown in FIG. 1) one or a plurality of filters (loop filter components/subfilters), e.g., one or more of different kinds or types of filters, e.g., connected in series or in parallel or in any combination thereof, wherein each of the filters may comprise individually or jointly with other filters of the plurality of filters a filter analysis unit to determine the respective loop filter parameters, e.g., as described in the previous paragraph.

Embodiments of the encoder 100 (respectively loop filter unit 120) may be configured to output the loop filter parameters, e.g., directly or entropy encoded via the entropy encoding unit 170 or any other entropy coding unit, so that, e.g., a decoder 200 may receive and apply the same loop filter parameters for decoding.

The decoded picture buffer (DPB) 130 is configured to receive and store the filtered block 121. The decoded picture buffer 130 may be further configured to store other previously filtered blocks, e.g., previously reconstructed and filtered blocks 121, of the same current picture or of different pictures, e.g., previously reconstructed pictures, and may provide complete previously reconstructed, i.e., decoded, pictures (and corresponding reference blocks and samples) and/or a partially reconstructed current picture (and corresponding reference blocks and samples), for example, for inter estimation and/or inter prediction.

Further embodiments of the disclosure may also be configured to use the previously filtered blocks and corresponding filtered sample values of the decoded picture buffer 130 for any kind of estimation or prediction, e.g., intra and inter estimation and prediction.

### Motion Estimation and Prediction

The prediction unit 160, also referred to as block prediction unit 160, is configured to receive or obtain the picture block 103 (current picture block 103 of the current picture 101) and decoded or at least reconstructed picture data, e.g., reference samples of the same (current) picture from buffer 116 and/or decoded picture data 231 from one or a plurality of previously decoded pictures from decoded picture buffer 130, and to process such data for prediction, i.e., to provide a prediction block 165, which may be an inter-predicted block 145 or an intra-predicted block 155.

Mode selection unit 162 may be configured to select a prediction mode (e.g., an intra or inter prediction mode) and/or a corresponding prediction block 145 or 155 to be used as prediction block 165 for the calculation of the residual block 105 and for the reconstruction of the reconstructed block 115.

Embodiments of the mode selection unit 162 may be configured to select the prediction mode (e.g., from those supported by prediction unit 160), which provides the best match or in other words the minimum residual (minimum residual means better compression for transmission or storage), or a minimum signaling overhead (minimum signaling overhead means better compression for transmission or storage), or which considers or balances both. The mode selection unit 162 may be configured to determine the prediction mode based on rate distortion optimization (RDO), i.e., select the prediction mode which provides a minimum rate distortion optimization or which associated rate distortion at least a fulfills a prediction mode selection criterion.

In the following the prediction processing (e.g., prediction unit 160 and mode selection (e.g., by mode selection unit 162) performed by an example encoder 100 will be explained in more detail.

As described above, encoder 100 is configured to determine or select the best or an optimum prediction mode from a set of (pre-determined) prediction modes. The set of prediction modes may comprise, e.g., intra-prediction modes and/or inter-prediction modes.

The set of intra-prediction modes may comprise 32 different intra-prediction modes, e.g., non-directional modes like DC (or mean) mode and planar mode, or directional modes, e.g., as defined in H.264, or may comprise 65 different intra-prediction modes, e.g., non-directional modes like DC (or mean) mode and planar mode, or directional modes, e.g., as defined in H.265.

The set of (or possible) inter-prediction modes depend on the available reference pictures (i.e., previous at least partially decoded pictures, e.g., stored in DBP 230) and other inter-prediction parameters, e.g., whether the whole reference picture or only a part, e.g., a search window area around the area of the current block, of the reference picture is used for searching for a best matching reference block, and/or, e.g., whether pixel interpolation is applied, e.g., half/semi-pel and/or quarter-pel interpolation, or not.

Additional to the above prediction modes, skip mode and/or direct mode may be applied.

The prediction unit 160 may be further configured to partition the block 103 into smaller block partitions or sub-blocks, e.g., iteratively using quad-tree-partitioning (QT), binary partitioning (BT) or triple-tree-partitioning (TT) or any combination thereof, and to perform, e.g., the prediction for each of the block partitions or sub-blocks, wherein the mode selection comprises the selection of the tree-structure of the partitioned block 103 and the prediction modes applied to each of the block partitions or sub-blocks.

The inter estimation unit 142, also referred to as inter picture estimation unit 142, is configured to receive or obtain the picture block 103 (current picture block 103 of the current picture 101) and a decoded picture 231, or at least one or a plurality of previously reconstructed blocks, e.g., reconstructed blocks of one or a plurality of other/different previously decoded pictures 231, for inter estimation (or “inter picture estimation”). For example, a video sequence may comprise the current picture and the previously decoded pictures 231, or in other words, the current picture and the previously decoded pictures 231 may be part of or form a sequence of pictures forming a video sequence.

The encoder 100 may, e.g., be configured to select a reference block from a plurality of reference blocks of the same or different pictures of the plurality of other pictures and provide a reference picture (or reference picture index) and/or an offset (spatial offset) between the position (x, y coordinates) of the reference block and the position of the current block as inter estimation parameters 143 to the inter prediction unit 144. This offset is also called motion vector (MV). Generally, the inter estimation unit 142 generates motion information including at least the MV. The motion information generated by the inter estimation unit may also include MVD and MVP index, a MERGE index, and/or a FRUC/DMVD flag. The inter estimation is also referred to as motion estimation (ME) and the inter prediction also motion prediction (MP).

The inter prediction unit 144 is configured to obtain, e.g., receive, an inter prediction parameter 143 and to perform inter prediction based on or using the inter prediction parameter 143 to obtain an inter prediction block 145.

Although FIG. 1 shows two distinct units (or steps) for the inter-coding, namely inter estimation 142 and inter prediction 152, both functionalities may be performed as one (inter estimation typically comprises calculating an/the inter prediction block, i.e., the or a “kind of” inter prediction 154), e.g., by testing all possible or a predetermined subset of possible interprediction modes iteratively while storing the currently best inter prediction mode and respective inter prediction block, and using the currently best inter prediction mode and respective inter prediction block as the (final) inter prediction parameter 143 and inter prediction block 145 without performing another time the inter prediction 144.

The intra estimation unit 152 is configured to obtain, e.g., receive, the picture block 103 (current picture block) and one or a plurality of previously reconstructed blocks, e.g., reconstructed neighbor blocks, of the same picture for intra estimation. The encoder 100 may, e.g., be configured to select an intra prediction mode from a plurality of intra prediction modes and provide it as intra estimation parameter 153 to the intra prediction unit 154.

Embodiments of the encoder 100 may be configured to select the intra-prediction mode based on an optimization criterion, e.g. minimum residual (e.g., the intra-prediction mode providing the prediction block 155 most similar to the current picture block 103) or minimum rate distortion.

The intra prediction unit 154 is configured to determine based on the intra prediction parameter 153, e.g., the selected intra prediction mode 153, the intra prediction block 155.

Although FIG. 1 shows two distinct units (or steps) for the intra-coding, namely intra estimation 152 and intra prediction 154, both functionalities may be performed as one (intra estimation typically comprises calculating the intra prediction block, i.e., the or a “kind of” intra prediction 154), e.g., by testing all possible or a predetermined subset of possible intra-prediction modes iteratively while storing the currently best intra prediction mode and respective intra prediction block, and using the currently best intra prediction mode and respective intra prediction block as the (final) intra prediction parameter 153 and intra prediction block 155 without performing another time the intra prediction 154.

The entropy encoding unit 170 is configured to apply an entropy encoding algorithm or scheme (e.g., a variable length coding (VLC) scheme, an context adaptive VLC scheme (CALVC), an arithmetic coding scheme, a context adaptive binary arithmetic coding (CABAC)) on the quantized residual coefficients 109, inter prediction parameters 143, intra prediction parameter 153, and/or loop filter parameters, individually or jointly (or not at all) to obtain encoded picture data 171 which can be output by the output 172, e.g., in the form of an encoded bitstream 171. The encoded bitstream 171 may be transmitted to the decoder 200. According to the present disclosure, the encoder 100 may signal absolute values of the motion information generated in the inter estimation unit 142 to the decoder via the bitstream 171, particularly without signaling signs of the motion information. For example, absolute values of a MV or MVD may be transmitted. Optionally, the bitstream 171 also includes auxiliary information related to the signaled absolute values, as will be explained in detail further below.

FIG. 2 shows an exemplary video decoder 200 configured to receive encoded picture data (e.g., encoded bitstream) 171, e.g., encoded by encoder 100, to obtain a decoded picture 231.

The decoder 200 comprises an input 202, an entropy decoding unit 204, an inverse quantization unit 210, an inverse transformation unit 212, a reconstruction unit 214, a buffer 216, a loop filter 220, a decoded picture buffer 230, a prediction unit 260 (including an inter prediction unit 244, and an intra prediction unit 254), a mode selection unit 260 and an output 232.

The entropy decoding unit 204 is configured to perform entropy decoding to the encoded picture data 171 to obtain, e.g., quantized coefficients 209 and/or decoded coding parameters (not shown in FIG. 2), e.g., (decoded) any or all of inter prediction parameters 143, intra prediction parameter 153, and/or loop filter parameters. In particular, the decoder 200 may in this way receive the absolute values of the motion information signaled by the encoder 100, and optionally the auxiliary information, from the received encoded picture data 171, as explained in more detail further below.

In embodiments of the decoder 200, the inverse quantization unit 210, the inverse transformation unit 212, the reconstruction unit 214, the buffer 216, the loop filter 220, the decoded picture buffer 230, the prediction unit 260 and the mode selection unit 260 are configured to perform the inverse processing of the encoder 100 (and the respective functional units) to decode the encoded picture data 171.

In particular, the inverse quantization unit 210 may be identical in function to the inverse quantization unit 110, the inverse transformation unit 212 may be identical in function to the inverse transformation unit 112, the reconstruction unit 214 may be identical in function reconstruction unit 114, the buffer 216 may be identical in function to the buffer 116, the loop filter 220 may be identical in function to the loop filter 220 (with regard to the actual loop filter as the loop filter 220 typically does not comprise a filter analysis unit to determine the filter parameters based on the original image 101 or block 103 but receives (explicitly or implicitly) or obtains the filter parameters used for encoding, e.g. from entropy decoding unit 204), and the decoded picture buffer 230 may be identical in function to the decoded picture buffer 130.

The prediction unit 260 may comprise an inter prediction unit 244 and an inter prediction unit 254, wherein the inter prediction unit 144 may be identical in function to the inter prediction unit 144, and the inter prediction unit 154 may be identical in function to the intra prediction unit 154. The prediction unit 260 and the mode selection unit 262 are typically configured to perform the block prediction and/or obtain the predicted block 265 from the encoded data 171 only (without any further information about the original image 101) and to receive or obtain (explicitly or implicitly) the prediction parameters 143 or 153 and/or the information about the selected prediction mode, e.g. from the entropy decoding unit 204.

The decoder 200 is configured to output the decoded picture 230, e.g., via output 232, for presentation or viewing to a user.

FIG. 4 shows a device 400 according to an embodiment of the present disclosure. In particular, the device 400 is for encoding video images, i.e., it is an encoding device 400. The device 400 may specifically be the encoder 100 shown in FIG. 1, or may be implemented into the encoder 100 of FIG. 1 (specifically into the inter estimation unit 142 as described further below).

The device 400 comprises a processor 401, or other processing circuitry, configured to implement several actions or steps related to the generation of motion information. The processor 401 may be a processor of the encoder 100 of FIG. 1. The device 400 further comprises a transmitter 406 configured to transmit motion information to an encoder 200. The transmitter 406 may be included in or may be the entropy encoding unit 170 of the encoder 100 shown in FIG. 1. That is, “transmitting” here means that the transmitter 406 encodes information into the encoded picture data 171, i.e., into the encoded bitstream 171.

The processor 401 is configured to generate motion information 402 (e.g., a MV, MVP, MVP index, MVD, and/or a list of MVs/MVDs, etc.), build motion information candidates 403 based on absolute values 407 of the generated motion information 402 (e.g., absolute values 407 of the MV or MVD). Each motion information candidate 403 (e.g., a MV or MVD candidate) results from a different sign combination of the absolute values 407. Further, the processor 401 is configured to calculate a cost 404 for each motion information candidate 403. A cost may be calculated based on a distortion metric and/or based on template/bilateral matching. Then, the processor 401 is configured to determine a rank 405 of each motion information candidate 403 based on the calculated costs 404.

The transmitter 406 is configured to transmit the absolute values 407 of the generated motion information 402 to the encoder 200. In particular, the transmitter 406 is configured to transmit these absolute values 407 of the motion information 402 without sending the corresponding signs, i.e., it is configured to not transmit the signs of the motion information 402.

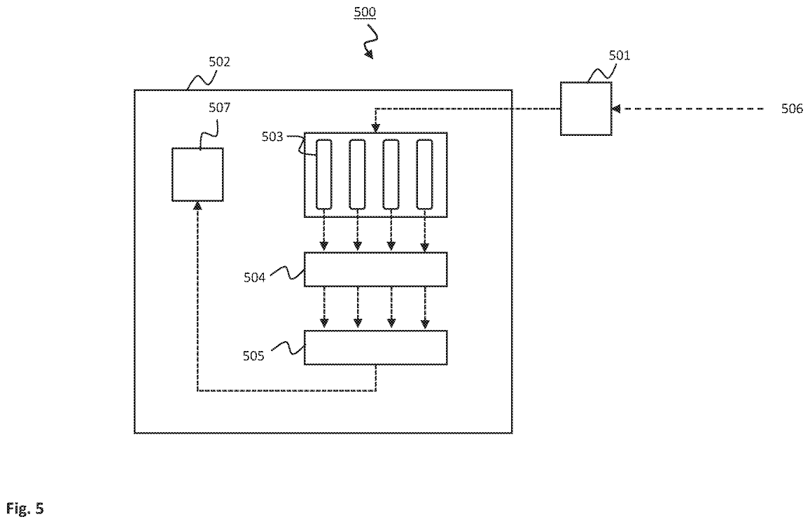

FIG. 5 shows a device 500 according to another embodiment of the present disclosure. In particular, the device 500 is for decoding video images. The device 500 may specifically be the decoder 200 shown in FIG. 2, or may be implemented in the decoder 200 of FIG. 2. The device 500 comprises a receiver 501 configured to receive (amongst other information) absolute values 506 of motion information 507, e.g., these absolute values 506 are included in the encoded picture data 171 sent from the encoder 100 to the decoder 200. Accordingly, the absolute values 506 may be the absolute values 407 of the motion information 402. The receiver 501 may be included in or may be the entropy decoding unit 204 shown in FIG. 2. Further, the device 500 comprises a processor 502, or other processing circuitry, configured to implement several actions or steps related to the determination of motion information. The processor 502 may be a processor of the decoder 200.

In particular, the processor 502 is configured to generate motion information candidates 503 based on the received absolute values 506. Ideally, these motion information candidates 503 are the same as the motion information candidates 403 generated in the encoding device 400 of the encoder 100. Each motion information candidate 503 results from a different sign combination of the received absolute values 506. Further, the processor 502 is configured to calculate a cost 504 for each motion information candidate 503. The cost calculation may be carried out as in the encoding device 400. Further, the processor 502 is configured to determine a rank 505 of each motion information candidate 503 based on the calculated costs 504. Then, the processor 502 is configured to determine a motion information candidate 503 to be the motion information 507 based on the determined ranks 505. In this way, the device 500 can determine the motion information 507, e.g., the motion information 402 generated in the device 400 of the encoder 100, although the signs of this motion information 402 were not signaled in the bitstream 171.

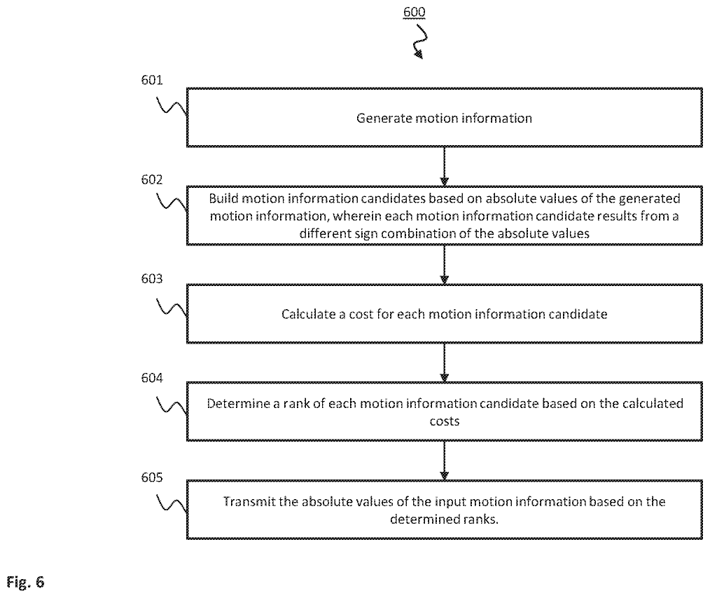

FIG. 6 shows a method 600 according to an embodiment of the present disclosure. The method 600 is particularly for encoding video images, and can be performed by the device 400 shown in FIG. 4 and/or the encoder 100 shown in FIGS. 1 and 5, respectively. The method 600 comprises a step 601 of generating motion information 402, a step 602 of building motion information candidates 403 based on absolute values 407 of the generated motion information 402, wherein each motion information candidate 403 results from a different sign combination of the absolute values 407, a step 603 of calculating a cost 404 for each motion information candidate 403, and a step 604 of determining a rank 405 of each motion information candidate 403 based on the calculated costs 404. The steps 601 to 604 may be performed by the processor 401 of device 400 or by processing circuitry of the encoder 100. Further, the method 600 comprises a step 605 of transmitting the absolute values 407 of the generated motion information based on the determined ranks. The step 605 may be performed by the transmitter 406 of device 400 or by the encoding unit 170 of encoder 100.

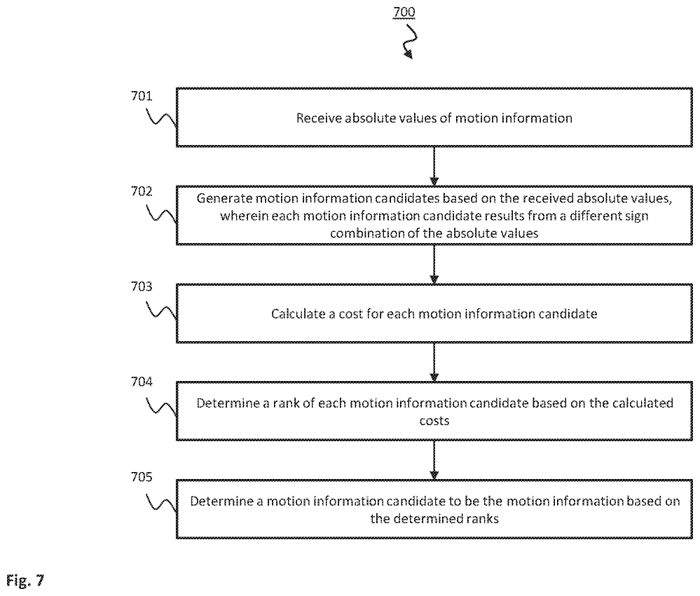

FIG. 7 shows a method 700 according to an embodiment of the present disclosure. The method 700 is particularly for decoding video images, and can be performed by the device 500 shown in FIG. 5, and/or the decoder 200 shown in FIG. 2. The method 700 comprises a step 701 of receiving absolute values 506 of motion information. This step 701 may be performed by the receiver 501 of device 500 or by the decoding unit 204 of decoder 200. Further, the method 700 comprises a step 702 of generating motion information candidates 503 based on the received absolute values 506, wherein each motion information candidate 503 results from a different sign combination of the absolute values 506, a step 703 of calculating a cost 504 for each motion information candidate 503, a step 704 of determining a rank 505 of each motion information candidate 503 based on the calculated costs 504, and a step 705 of determining a motion information candidate 503 to be the motion information 507 based on the determined ranks 505. The steps 702 to 705 may be performed by the processor 502 of device 500 or by processing circuitry of the decoder 200.

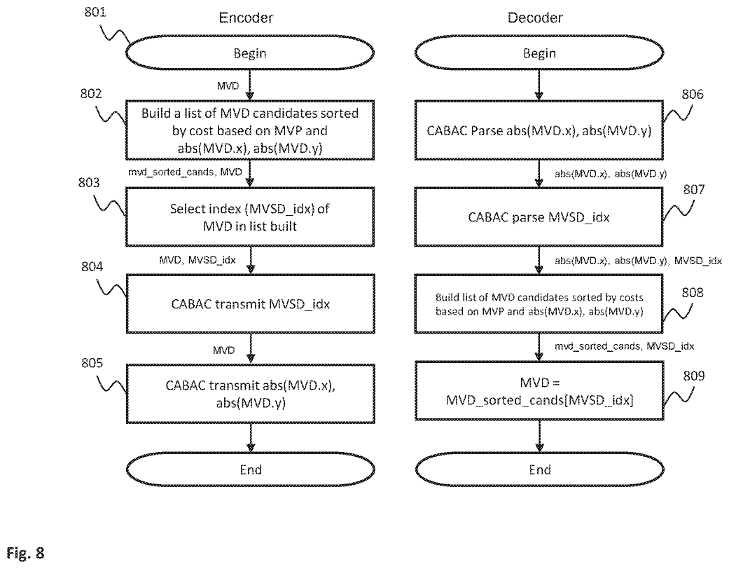

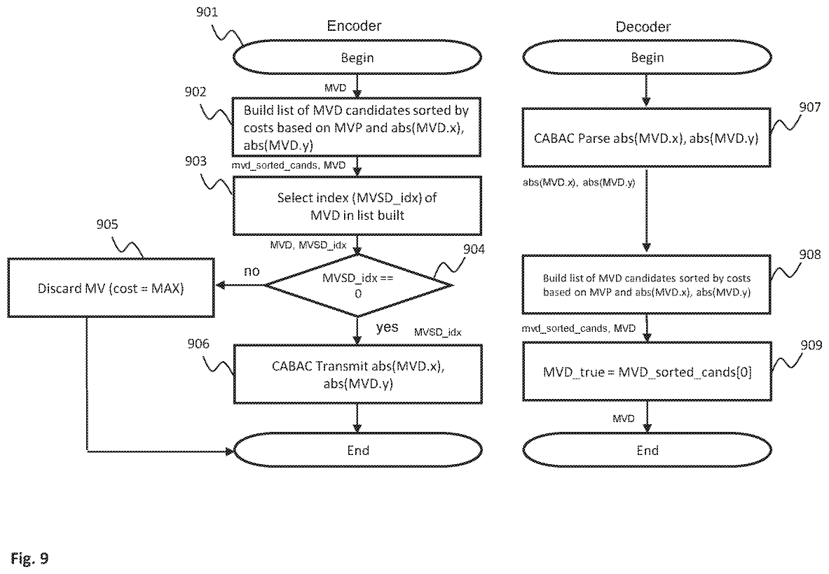

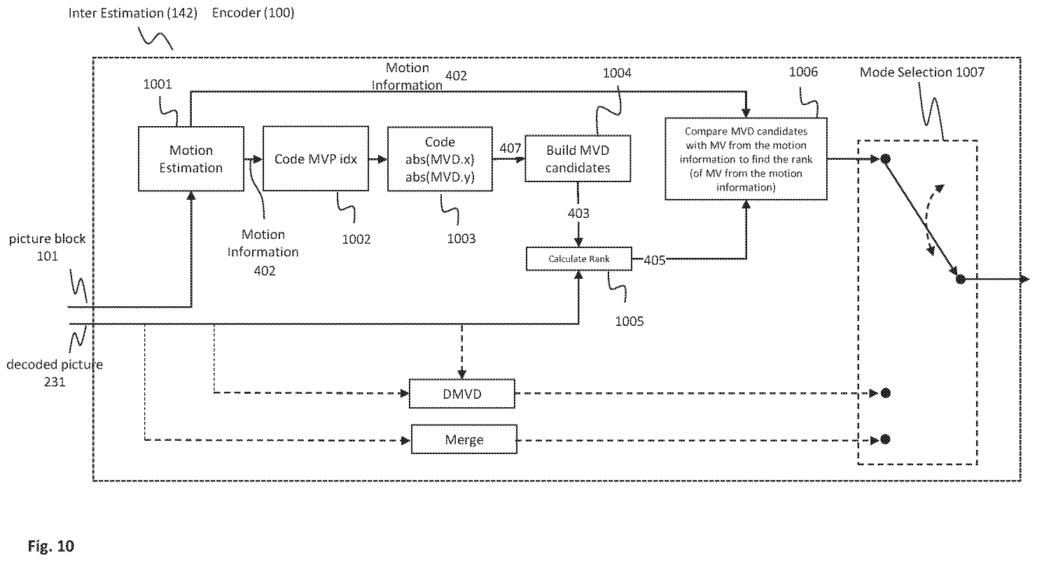

In the following, further details are described, which build on the general embodiments of the present disclosure described with respect to the FIGS. 4 to 7, respectively. In particular, as examples, two specific embodiments of the present disclosure are described. The two specific embodiments are described with respect to the FIGS. 8 and 9 and the FIGS. 10 to 13, respectively. In both specific embodiments, the motion information transmission from the encoder 100 to the decoder 200 is implemented by the device 400 shown in FIG. 4. Likewise, the determination of the motion information in the decoder 200 is implemented by the device 500 shown in FIG. 5.

In the first specific embodiment, generally, the device 400 in the encoder 100 is configured to transmit auxiliary information to the decoder 200. In particular, it is configured to transmit the determined rank of the motion information candidate 403 corresponding to the generated motion information 402 to the decoder 200. This rank may be an index in a motion information candidate list. In this case, the device 400 may be configured to generate an indexed list of the motion information candidates 403 sorted by their ranks, to determine an index in the list of the motion information candidate 403 corresponding to the generated motion information 402. The device 400 may transmit the determined index to the decoder 200. The device 500 in the decoder 200 receives the rank from the encoding device 400, and is configured to determine a motion information candidate 503 with a rank according to the received rank to be the motion information 402. In the case that the received rank is an index, the device 500 is configured to generate an indexed list of the motion information candidates 503 sorted by their ranks, and determine a motion information candidate 503 with an index in the list according to the received index to be the motion information 507/402.

In the second specific embodiment, generally, the device 400 in the encoder 100 is configured to not transmit auxiliary information to the decoder 200. That is, it does not transmit the determined rank. However, the device 400 is configured to determine, whether a motion information candidate 403 with a determined rank according to a lowest calculated cost 404 corresponds to the generated motion information 402. Further, it is configured to discard the generated motion information 402, if the determined motion information candidate 403 does not correspond to the generated motion information 402. Only if the determined motion information candidate 403 does correspond to the generated motion information 402, the device 400 is configured to send the absolute values (but not its rank) to the decoder 200. The device 500 in the decoder 200 is configured to determine a motion information candidate 503 with a rank corresponding to a lowest calculated cost 504 to be the motion information 507/402.

A flow chart of a possible implementation of the first specific embodiment is now illustrated in FIG. 8. The device 400 in the encoder 100 is configured to generate (at block 801) the motion information 402, which here includes a MVD, with signs by inter-estimation. Then, the device 400 is configured to build (at block 802) a list of possible MVD candidates 403 based on the absolute values 407 of the MVD with all possible sign combinations. Then (still at block 802) the device 400 is configured to use reconstructed pictures from a DPB to perform, for instance by using template or bilateral matching, a cost 404 calculation for each MVD candidate 403. Then (still at block 802) the device 400 may be configured to sort the candidates list according to the calculated costs 404, for example in ascending order. Sorting should yield the same result both in the encoder 100 and the decoder 200, and may include candidates 403 with the same costs 404. If two candidates 403 have the same cost 404, their relative order in the sorted list should be the same in the encoder 100 and the decoder 200.

Then, the device 400 is configured (at block 803) to identify a position of the generated MVD in the MVD candidates list. Here, the position of the MVD is identified by an index (MVSD_idx), which is a specific implementation of the above-mentioned rank determined in the device 400. The device 400 is further configured to signal this index via the bitstream 171 to the decoder 200, for example, by using the entropy encoding unit 170 (CABAC) and/or a binarization of geometric distribution (e.g., unary code or truncated unary code). In other words, the device 400 is configured to transmit the index to the decoder 200. The device 400 is also configured (at block 804) to transmit the absolute values 407 of the generated MVD (in the bitstream 171) to the decoder 200.

The device 500 in the decoder 200 is configured—in this implementation of the first specific embodiment—to read (at blocks 806 and 807) the absolute values 506 of the MVD and the index (MVSD_idx), respectively, from the bitstream 171 received from the encoder 100. Then, the device 500 is configured to repeat the same procedure as the device 400 in the encoder 100. Namely, the device 500 is now configured to (at block 808) build the sorted list of MVD candidates 503 based on the received absolute values 506 of the MVD, wherein these candidates 503 are ideally the same as the candidates 403 obtained at the encoder 100. The device 500 is then configured to determine the MVD (i.e., motion information 507), e.g., the motion information 402 generated by the device 400 in the encoder 100, by taking the MVD candidate 503 from the candidates list at the position of the index (block 809). This determined MVD is used for further reconstruction process (e.g. of the MV) at the decoder 200.

A flow chart of a possible implementation of the second specific embodiment is illustrated in FIG. 9. The device 400 in the encoder 100 is configured to generate (at block 901) the motion information 402, including a MVD, with signs from inter estimation. Then, it builds (at block 902) a list of possible MVD candidates 403 with all possible signs combination of the absolute values 407 of the MVD. Then, it performs (still at block 902) a cost 404 calculation for each MVD candidate 403, for instance by using reconstructed pictures from a DPB and template or bilateral matching. Then, it sorts (still at block 902) the candidates list according to the calculated costs 404, e.g., in ascending order. Sorting should yield the same results in the encoder 100 and the decoder 200, and may include candidates 403 with same cost 404. If two candidates 403 have the same cost 404, their relative order in the sorted list should be the same at the encoder 100 and the decoder 200.

Then (at block 903) the device 400 selects the index of the generated MVD in the list of candidates 403. If then (at block 904) the device 400 determines that the MVD candidate 403 at the first position (MVSD_idx=0) of the list is not equal to the generated MVD, as obtained by inter estimation, the generated motion information 402 (particularly the MV corresponding to the MVD) is discarded (at block 905) by the motion estimation process, and the inter estimation should consider another MV/MVD. Notably, the device 400 does not necessarily need to perform a sorting of the entire candidate list. It may just choose the MVD candidate 403 with the lowest cost 404. Sorting is just an exemplary way to obtain the MVD candidate 403 with minimum cost 404. If the MVD candidate 403 with minimum cost 404 is equal to the generated MVD of the motion information 402, then the device 400 (at block 906) writes the absolute values of the generated MVD into the bitstream, for transmission to the decoder 200.

The device 500 in the decoder 200 is configured—in this implementation of the second specific embodiment—to read (at block 907) the absolute values 506/407 of the MVD from the bitstream 171 received from the encoder 100, and is configured to repeat (at block 908), same procedure performed by the device 400 in the encoder 100, namely for obtaining the MVD candidate 403 with the minimum cost 404. This MVD candidate 403 is then used as the MVD for further reconstruction process (e.g. of the MV) in the decoder 200.

FIG. 10 shows—for a possible implementation of the first specific embodiment—how the device 400 may be integrated into the encoder 100 of FIG. 1, particularly how parts of the device 400 may be integrated into the inter estimation unit 142. The inter estimation unit 142 is configured to generate motion information 402, namely by performing motion estimation (at block 1001). The motion information 402 may include MV, MVP and MVD. The inter estimation unit 142 then further codes from the motion information 402 (at block 1102) a MVP index of the MVP, and (at block 1103) absolute values 407 of the MVD. In some implementation forms Motion Vector Prediction may not be used or has zero vector in the prediction. For such cases absolute value of MV is used for further processing. Based on these absolute values 407 of the MVD, the inter estimation unit 142 further builds (at block 1004) MVD candidates 403. For these MVD candidates 403, the inter estimation unit 142 also calculates costs 404 and determines (at block 1005) a rank 405 for each MVD candidate 403. Then, it compares (at block 1006) the MVD candidates 403 with the MVD from the motion information 402 (generated at block 1001), in order to find the rank of the MVD candidate corresponding to the MVD of the motion information 402. Then, the absolute values 407 of the MVD and the rank are output from the inter-estimation unit 142, and are in the end transmitted by the transmitter 406 of the device 400 (encoding unit 170 of FIG. 1) to the decoder 200.

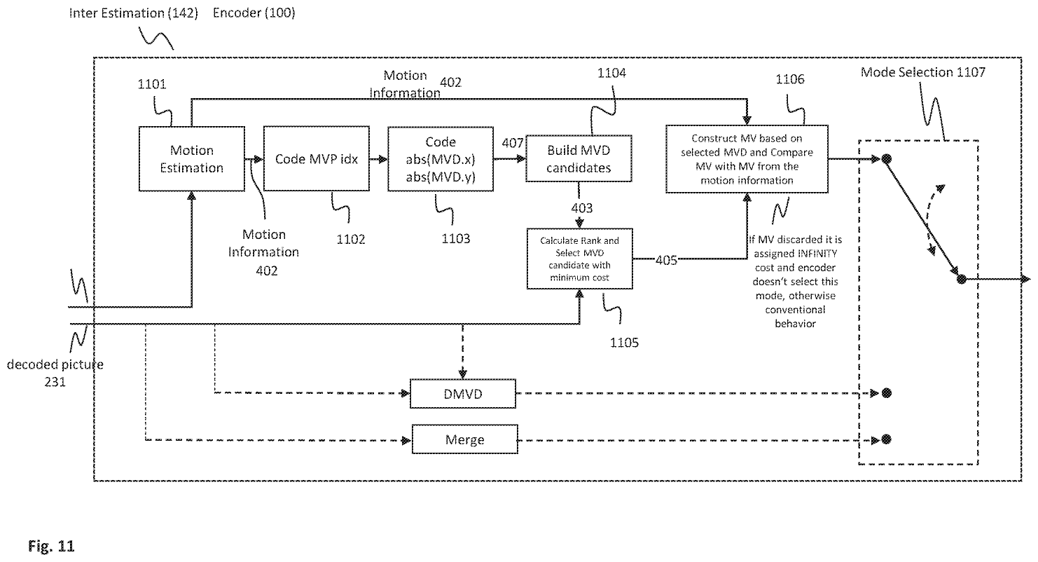

FIG. 11 shows—for a possible implementation of the second specific embodiment—how the device 400 may be integrated into the encoder 100 of FIG. 1, particularly how parts of the device 400 may be integrated into the inter estimation unit 142. The inter estimation unit 142 is configured to generate motion information 402 including MV, MVP and MVD, namely by motion estimation (block 1101). The inter estimation unit 142 further codes (block 1102) a MVP index of the MVP and codes (block 1103) absolute values 407 of the MVD. Based on the absolute values of the MVD, the inter estimation unit 142 builds (at block 1104) MVD candidates 403. For these MVD candidates 403, the inter estimation unit 142 also calculates costs 404, and then determines (at block 1105) a rank 405 for each MVD candidate 403. Then, it selects the MVD candidate 403 with the minimum cost 404, and constructs a MV based on the selected MVD (at block 1106). Then (still at block 1106) it compares the constructed MV with the MV in the generated motion information 402, and discards the motion information 402, if the MVs do not match. In particular, for discarding, it assigns infinity cost, and accordingly the encoder 100 will not select this mode (in a mode selection block 1107). Otherwise, the absolute values 407 of the MVD are transmitted to the decoder 200. This may be done by the transmitter 406 of the device 400, e.g. the encoding unit 170 of the encoder 100.

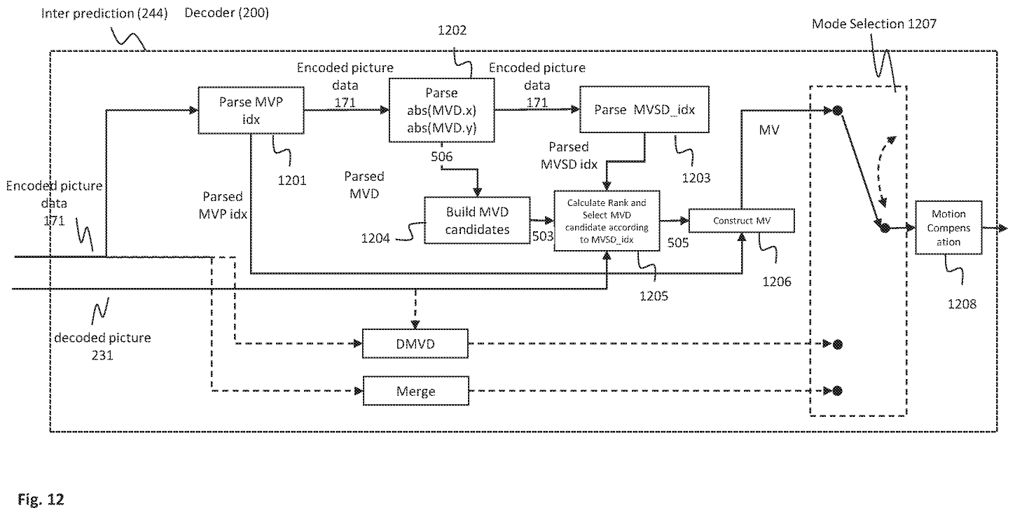

FIG. 12 shows—for a possible implementation of the first specific embodiment—how the device 500 may be integrated into the decoder 200 of FIG. 2, particularly how parts of the device 500 may be integrated into the inter prediction unit 244. The inter prediction unit 244 is configured to receive (e.g., via an entropy decoding unit 204 as receiver 501 of the device 500) encoded picture data 171 from the encoder 100, and to parse the received data 171 (at block 1201) for an MVP index. Further, it parses (at block 1202) the received data 171 for absolute values 506 of motion information 507, here absolute values 506 of MVD. Further, it parses the received data 171 (at block 1203) for a rank, specifically for an index (MVSD_idx), transmitted by the encoder 100 as auxiliary information.

The inter prediction unit 244 is further configured to build MVD candidates 503 (at block 1204) based on the absolute values. For each of these candidates 503 it calculates (at block 1205) a rank 505, specifically an index in the list of candidates 503. It also selects the MVD candidate 503 according to the index it parsed (at block 1203), i.e., it selects the MVD candidate 503 with the index that corresponds to the received (MVSD_idx) index. Based on the selected MVD the inter prediction unit 244 can construct (at block 1206) a MV, which is provided to mode selection (block 1207), which decides on a MV to perform further motion compensation (block 1207).

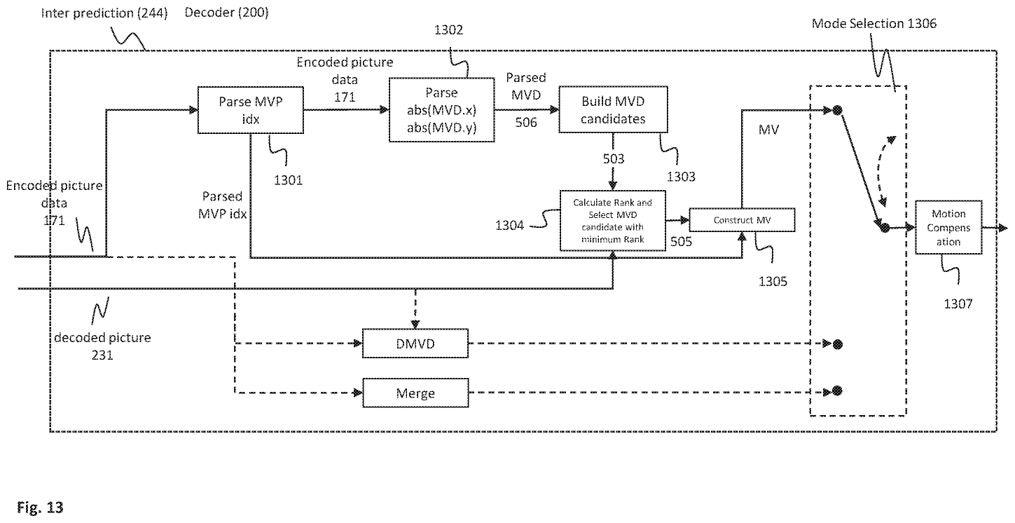

FIG. 13 shows—for a possible implementation of the second specific embodiment—how the device 500 may be integrated into the decoder 200 of FIG. 2, particularly how parts of the device 500 may be integrated into the inter prediction unit 244. The inter prediction unit 244 is configured to receive (e.g., via an entropy decoding unit 204 as receiver 501 of the device 500) encoded picture data 171 from the encoder 100, and to parse the received data 171 (at block 1301) for an MVP index. Further, it parses (at block 1302) the received data 171 for absolute values 506 of motion information 507, here absolute values 506 of MVD.

The inter prediction unit 244 is further configured to build MVD candidates 503 (at block 1303) based on the absolute values. For each of these candidates 503 it calculates (at block 1304) a rank 505, specifically an index in the list of candidates 503. It then selects the MVD candidate 503 with the minimum cost 504. Based on the selected MVD, the inter prediction unit 244 can the construct (at block 1305) a MV, which is provided to mode selection (block 1306), which decides on a MV to perform further motion compensation (block 1307).

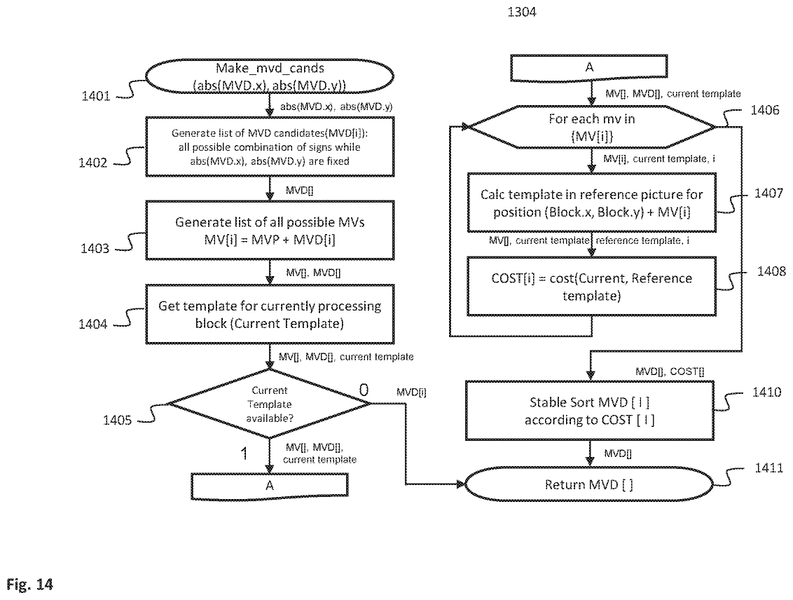

FIG. 14 shows in more detail how the list of MVD candidates 403/503 may be constructed by the device 400 in the encoder 100 and/or the device 500 in the decoder 200. The MVD candidate list construction is the same in the first and second specific embodiment. The list may be sorted according to template/bilateral matching cost 404/504. Sorting should yield the same result both in the encoder 100 and decoder 200, and may include candidates 403/503 with the same costs 404/504. If two candidates 403/503 have the same cost 404/504, their relative order in the sorted list should be the same at the encoder 100 and decoder 200. For the first specific embodiment, the cost function may include both a distortion metric (e.g., SAD, SSD, MSE) and a bits estimation required to signal the (MVSD_idx) index combined in the cost function with, for instance, the help of a Lagrangian multiplayer (lambda).

In particular in FIG. 14, absolute values of an MVD are used as input (block 1401), and a list of MVD candidates 403/503 is generated (at block 1402). Then (at block 1403), a list of all possible MVs is generated based on MVPs and MVDs. Then (at block 1404) a template is obtained for the currently processed image block. If no template is available (block 1405), for instance at corners at the image, then the MVD is returned (at block 1411). If a template is available (at block 1405), then (at blocks 1406 to 1408) for each MV a template in the reference picture for a certain position (i.e., position of currently processed image block plus the MV) is calculated, and a cost 404/504 is obtained by calculating difference between current and reference picture templates. Then (at block 1410) the MVD candidates are sorted by cost 404/504, and returned (at block 1411).

Note that this specification provides explanations for pictures (frames), but fields substitute as pictures in the case of an interlace picture signal.

The person skilled in the art will understand that the “blocks” (“units”) of the various figures (method and apparatus) represent or describe functionalities of embodiments of the disclosure (rather than necessarily individual “units” in hardware or software) and thus describe equally functions or features of apparatus embodiments as well as method embodiments (unit=step).

The terminology of “units” is merely used for illustrative purposes of the functionality of embodiments of the encoder/decoder and are not intended to limiting the disclosure.

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present disclosure may be integrated into one processing unit, or each of the units may exist alone physically, or two or more units are integrated into one unit.

Embodiments of the disclosure may further comprise an apparatus, e.g. encoder and/or decoder, which comprises a processing circuitry configured to perform any of the methods and/or processes described herein.

Embodiments of the encoder 100 and/or decoder 200 may be implemented as hardware, firmware, software or any combination thereof. For example, the functionality of the encoder/encoding or decoder/decoding may be performed by a processing circuitry with or without firmware or software, e.g. a processor, a microcontroller, a digital signal processor (DSP), a field programmable gate array (FPGA), an application-specific integrated circuit (ASIC), or the like.

The functionality of the encoder 100 (and corresponding encoding method 100) and/or decoder 200 (and corresponding decoding method 200) may be implemented by program instructions stored on a computer readable medium. The program instructions, when executed, cause a processing circuitry, computer, processor or the like, to perform the steps of the encoding and/or decoding methods. The computer readable medium can be any medium, including non-transitory storage media, on which the program is stored such as a Blu ray disc, DVD, CD, USB (flash) drive, hard disc, server storage available via a network, etc.

An embodiment of the disclosure comprises or is a computer program comprising program code for performing any of the methods described herein, when executed on a computer.

An embodiment of the disclosure comprises or is a computer readable medium comprising a program code that, when executed by a processor, causes a computer system to perform any of the methods described herein.

1. A device for decoding video images, comprising
a receiver configured to receive absolute values of motion information, and
a processor configured to:
generate motion information candidates based on the received absolute values, wherein each motion information candidate results from a different sign combination of the received absolute values,
calculate a cost for each motion information candidate,
determine a rank of each motion information candidate based on the calculated costs, and
determine a motion information candidate to be the motion information based on the determined ranks.

2. The device according to claim 1, wherein:
the receiver is further configured to receive an index, and
the processor is configured to:
determine a motion information candidate according to the received index to be the motion information.

3. The device according to claim 2, wherein:
the processor is configured to:
generate an indexed list of the motion information candidates sorted by corresponding ranks, and
determine the motion information candidate with the index in the indexed list according to the received index to be the motion information.

4. The device according to claim 1, wherein:
the processor is configured to:
determine the motion information candidate with the rank corresponding to a lowest calculated cost to be the motion information.

5. The device according to claim 1, wherein:
the processor is configured to:
calculate the cost for each motion information candidate by template or bilateral matching, particularly based on a sum of absolute differences or another distortion metric.

6. The device according to claim 1, wherein:
the processor is configured to:
exclude one of two motion information candidates, which differ only in the sign of at least one zero value.

7. The device according to claim 1, wherein
the processor is configured to:
calculate the cost for each motion information candidate taking into account the amount of bits it would require to transmit its rank.

8. A device for encoding video images, comprising
a processor configured to:
generate motion information,
build motion information candidates based on absolute values of the generated motion information, wherein each motion information candidate results from a different sign combination of the absolute values,
calculate a cost for each motion information candidate, and
determine a rank of each motion information candidate based on the calculated costs; and
a transmitter configured to transmit the absolute values of the generated motion information based on the determined ranks.

9. The device according to claim 8, wherein:
the transmitter is configured to transmit the rank of the motion information candidate corresponding to the generated motion information.

10. The device according to claim 8, wherein:
the processor is configured to:
calculate the cost for each motion information candidate taking into account the amount of bits required to transmit the rank for the motion information candidate.

11. The device according to claim 9, wherein:
the processor is configured to:
generate an indexed list of the motion information candidates sorted by corresponding ranks, and
determine an index in the indexed list of the motion information candidate corresponding to the generated motion information, and
the transmitter is configured to transmit the determined index.

12. The device according to claim 8, wherein:
the processor is configured to
determine whether a motion information candidate with rank according to a lowest calculated cost corresponds to the generated motion information, and
discard the generated motion information, responsive to determining that the motion information candidate does not correspond to the generated motion information.

13. The device according to claim 8, wherein:
the processor is configured to calculate the cost for each motion information candidate by template or bilateral matching, based on a sum of absolute differences or another distortion metric.

14. The device according to claim 8, wherein:
the processor is configured to:
exclude one of two motion information candidates, which differ only in the sign of at least one zero value.

15. A method for decoding video images, comprising
receiving absolute values of motion information,
generating motion information candidates based on the received absolute values, wherein each motion information candidate results from a different sign combination of the received absolute values,
calculating a cost for each motion information candidate,
determining a rank of each motion information candidate based on the calculated costs, and
determining a motion information candidate to be the motion information based on the determined ranks.

16. A method for encoding video images, comprising
generating motion information,
building motion information candidates based on absolute values of the generated motion information, wherein each motion information candidate results from a different sign combination of the absolute values,
calculating a cost for each motion information candidate,
determining a rank of each motion information candidate based on the calculated costs, and
transmitting the absolute values of the generated motion information based on the determined ranks.

17. A computer program product storing program code for performing the method according to claim 15 when the computer program runs on a computer.
